(19) United States
(12) Patent Application Publication
(10) Pub. No.: US 2026/0238041 A1
(43) Pub. Date: Aug. 13, 2026

(54) CHARGING SLAB FOR AN ELECTRONIC DEVICE

(71) Applicant: Jacob B. Marks, Chicago, IL (US)

(72) Inventors: Jacob B. Marks, Chicago, IL (US); Travis Bee, Chicago, IL (US)

(21) Appl. No.: 19/537,288

(22) Filed: Feb. 11, 2026

Related U.S. Application Data
(60) Provisional application No. 63/757,295, filed on Feb. 11, 2025.
(60) Provisional application No. 63/871,583, filed on Aug. 27, 2025.

(51) Int. Cl. H02J 50/10; H02J 7/00; H02J 7/02; H02J 50/12

(52) U.S. Cl. CPC H02J 50/10; H02J 7/00; H02J 7/02; H02J 50/12

(57) ABSTRACT

Embodiments of a charging slab for an electronic device include a slab with a plurality of point sources of light which emit from the slab surface indicating the location of a power transmitting coil that is contained in a cavity within the slab. The point sources of light are formed by a matrix of light generators, which are individually addressable and controlled by a computer or microcontroller, generating a light display that is propagated through light propagating volumes.

### CROSS-REFERENCE TO RELATED APPLICATIONS

This application claims the benefit under 35 U.S.C. § 119(e) of U.S. Provisional Patent Application No. 63/757,295, filed Feb. 11, 2025, and U.S. Provisional Patent Application No. 63/871,583, filed Aug. 27, 2025, both of which are incorporated herein by reference in their entirety.

### FIELD OF INVENTION

The disclosure relates to wired and wireless charging slabs and more particularly to charging pads and charging tables for electronic devices such as mobile telephones, portable computers, wearable electronic devices, and battery powered biomedical devices.

### BACKGROUND OF INVENTION

Wireless charging technology is becoming increasingly popular in everyday home and office environments with innovation being driven toward a cordless experience for the user. Much attention has been given to wireless charging pads that utilize LED displays to indicate to the user a docking location of an electronic device. For example, Kamarajugadda (U.S. Patent Application Publication No. 2025/0047115) discloses a wireless charging pad with a circular LED display. Furniture embedded wireless charging stations have also been explored by some, such as Gaskill (U.S. Patent Application Publication No. 2018/0097401) which discloses a wireless charger embedded in a power transfer table.

Most wireless chargers utilize coils of wire that transfer power from a wireless charger to a wireless charging receiver in order to charge the battery of an electronic device. The most popular wireless chargers utilize inductive coupling or resonant coil technology. Some other wireless chargers use radio frequency transmitters that are converted to electricity by a receiver. Many commercially produced wireless chargers adhere to the Qi standard, which is promulgated by the Wireless Power Consortium.

This invention provides a charging slab that acts as a reminder to the user that a battery for an electronic device is in a low condition that requires charging. The reminder provides a light display that acts as a visual cue that emanates from a charging slab to alert the user to the location of an embedded wireless charger, or power transmitting electrical contacts.

### BRIEF SUMMARY

This invention provides a charging slab for an electronic device that transmits and/or receives electromagnetic communication signals to or from a computer in the electronic device via a program or application. The charging slab has a microcontroller or computer which controls point sources of light emanating from the charging slab and initiates a light display and/or display routine of the point sources of light when it receives a command via electromagnetic communication from the electronic device.

The computer in the electronic device can look up and/or detect different properties of the battery contained in the electronic device, such as the state of charge (SOC), i.e. the amount of usable charge remaining in the battery and command the charging slab to act as a reminder to the user when the battery condition is detected as low. Other information such as battery level can be conveyed by the charging slab via the light display. In other embodiments the charging slab can act as a secondary notification platform, allowing the user to clone alerts received by the electronic device through the charging slab.

A light display is carried out by linking one or more matrices of light generators to one or more light propagating volumes, which allow light to propagate through and out of the slab surface from a plurality of terminal ends of the light propagating volumes, appearing to the user as point sources of light. The light propagating volumes may be fiber optic cables or light pipes with terminal ends that emit the point sources of light from the top of the slab in a desired shape, such as a circle, to create a light display and visual cue for the user. The point sources of light may emit in preconfigured patterns during different display modes to indicate to the user the battery level and to act as a reminder when the SOC of the battery in the electronic device is low. In another embodiment the charging slab acts as a low battery alert platform. In other embodiments the electronic device clones alerts and/or notifications received by the electronic device and commands the microcontroller in the charging slab to create a unique light display based on the type of alert or notification cloned.

### BRIEF DESCRIPTION OF DRAWINGS

FIG. 1 is a schematic perspective view of the first embodiment of the charging slab for an electronic device.

FIG. 2 is a schematic cross-sectional view of the first embodiment of the charging slab for an electronic device.

FIG. 3 is a schematic perspective view of an LED ring component of the first embodiment of the charging slab for an electronic device.

FIG. 4 is a schematic perspective view of a tray component of the first embodiment of the charging slab for an electronic device.

FIG. 5 is a schematic perspective view of a gasket component of the first embodiment of the charging slab for an electronic device.

FIG. 6 is a block flow diagram illustrating the operation of the charging slab for an electronic device.

FIGS. 7A and 7B show schematic plan views of an LED display routine created by the charging slab each with a different light display pattern.

FIG. 8 is a schematic isometric view of the second embodiment of the wireless charger for an electronic device.

FIG. 9 is a schematic cross-sectional view of the second embodiment of the wireless charger for an electronic device.

FIG. 10A is a schematic isometric view of the auxiliary components of the wireless charger for an electronic device in the third embodiment.

FIG. 10B is a schematic isometric view of the auxiliary components of the wireless charger for an electronic device in the third embodiment.

It is understood that these figures are for illustrative purposes and are not limited to the scale depicted unless otherwise stated. The proportions and shapes of some embodiments described may differ from the figures. Note that identical or corresponding components are denoted with the same reference numerals.

### DETAILED DESCRIPTION

The charging slab for an electronic device is composed of a slab with embedded components. The slab has a top surface that emits light emanating from a plurality of terminal ends of light propagating volumes contained within the slab. The slab material may be wood, plastic, or composite materials of wood and/or plastic, such as medium density fiber board. The slab may be a standalone piece of material or may be insertable into a larger slab for manufacturing convenience or for customized interchangeability. The charging slab may be at least part of a desk, charging pad, dock, charging table, stand, or the like, as is known in the art.

At least one slab surface may be painted white or black so that the terminal ends of the light propagating volumes are at least substantially camouflaged to the user while not emitting point sources of light. In a preferred embodiment, the light propagating volumes are light pipes.

### Embodiment 1

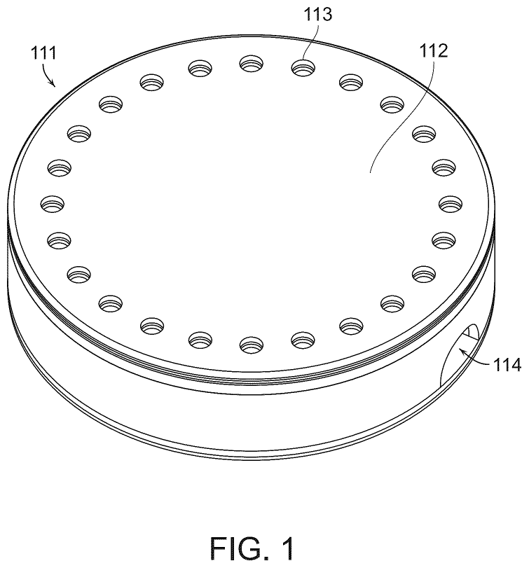

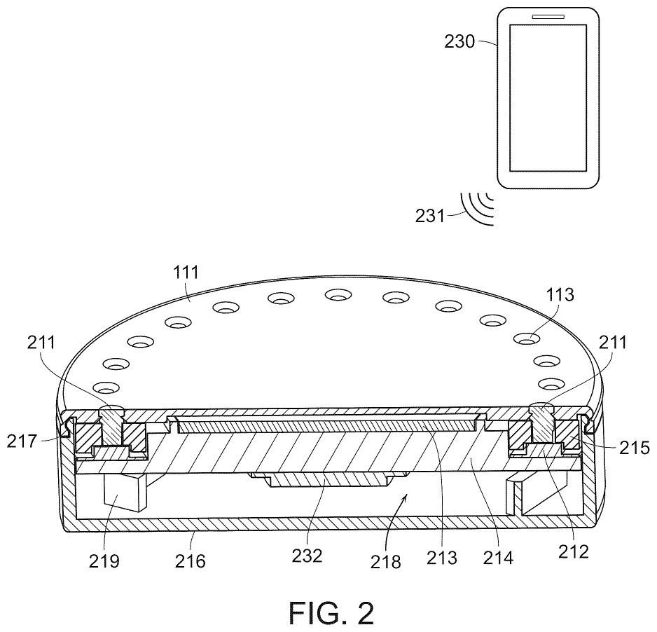

FIGS. 1 and 2 show a first embodiment of a charging slab with a cover 111 having a charging surface 112 where the electronic device can be placed by the user to recharge the battery of the electronic device.

Light pipe guide holes 113 allow for insertion of light pipes 211 into the charging slab so that they can propagate light emitted from the LED ring 212 out of the slab surface. The wireless charger 213 is seated in a circumferential lip located on tray 214. The circumferential lip may have a mating configuration with a circumferential groove on the underside of the cover 111 to allow for a slideable and/or guided assembly of the components. Gasket 215 is sandwiched between the LED ring 212 and cover 111. In an embodiment the gasket 215 is flexible and/or elastic such that the cover 111 and LED ring 212 exert a compressive force in a direction orthogonal to the slab surface while the charging slab is in an assembled state. In an embodiment the gasket 215 exerts a pinching and/or frictional force on the light pipes 211, holding the light pipes 211 in place. It is understood that the light pipes 211 fill every light pipe guide hole 113 when the charging slab is fully assembled. Cord slot 214 can be used to insert the electronics and allow an electrical cord to exit wireless charger 213.

Holder 216 houses the charging slab components such as tray 214, gasket 215, LED ring 212, and wireless charger 213. Holder 216 may have pegs (not shown) that allow the tray 214 to be seated and to restrict movement while the charging slab is fully assembled. Alternatively, the tray 214 may have pegs that are insertable into prismatic or cylindrical projections with bored insertion holes located on holder 216. In other embodiments, any other fastening means may be used that is known in the art such as screws or bolts. In an embodiment the holder 216 and cover 111 physically engage via a snap fit 217, however, any other joining means, such as mechanical fasteners and/or adhesive bonding may be used in place of, or in addition to snap fit 217.

Electronic components such as a PCB (not shown) and controller 232 may be housed in the PCB cavity 218. The PCB (not shown) can be retained by the PCB retention wall 219. In some embodiments, controller 232 is mounted on the PCB. In another embodiment, the LED ring 212 may be forgone and LEDs may be surface mounted on a PCB contained on the tray or in the holder 216. The controller 232 has a computer and/or microcontroller with electromagnetic communication capabilities, such as Wi-Fi, NFC, RFID, and/or Bluetooth® (trademark of Bluetooth SIG, Inc.). In other embodiments, tray 214 may contain a ferrite sheet or plate to prevent detuning from electromagnetic communication and to isolate electromagnetic absorbing/emitting components from each other, thereby reducing or preventing electromagnetic interference.

The materials used in and method of making the charging slab may be optimized for cost or for reliability. In an embodiment, the cover 111, tray 214, and holder 216 are manufactured by 3D printing, such as via FDM, SLS, or SLA 3D printers. In another embodiment the cover 111, tray 214, and holder 216 are manufactured by injection molding or by using a CNC machine on a slab of material. In an embodiment, the cover 111, tray 214, and holder 216 are made of PLA plastic, polyethylene, polypropylene, nylon 6, nylon 6/12, and/or blends thereof.

In an embodiment the light pipes 211 are made from acrylic or polycarbonate. In an embodiment the light pipes 211 are glass, fiber optic, polyethylene, or any other optically transparent or semitransparent material known in the art. In an embodiment the light pipes 211 are made from transparent and/or clear cast acrylic. In an embodiment the light pipes 211 are made by laser cutting clear cast acrylic or polycarbonate along a closed two-dimensional shape, such as a circle or star, such that the resulting three-dimensional shape is a prism or cylinder.

In an embodiment the light pipes 211 are dead fronted by changing the surface of the light pipes 211 or by overlaying a semitransparent layer over the light pipes 211 and/or slab surface so that the light pipes 211 appear at least substantially invisible to the user. In a further embodiment the light pipes 211 are made from transparent and/or clear cast acrylic that is coated and/or frosted on at least one side by a surface process such as sandblasting, laser etching, and/or sanding. In an embodiment the light pipe surface is altered by a layer additive or painting process such as spray coating, brush coating, or dip coating. In another embodiment at least part or all of the top surface of the cover 111 is covered with a layer of plastic, such as polyethylene or polypropylene, that is textured and/or micro-embossed to conceal the light pipes 211 when the LED ring 212 is not active. In an embodiment the layer of plastic may be black or white to conceal the light pipes 211 when the charging slab is not in use but are at least semi-transparent to light displays emanating from the charging slab while the LEDs are active. In another embodiment the light pipes 211 are dead fronted by being manufactured from acrylic or polycarbonate that is mixed with a semitransparent dye or pigment, such as carbon black, to conceal the LEDs.

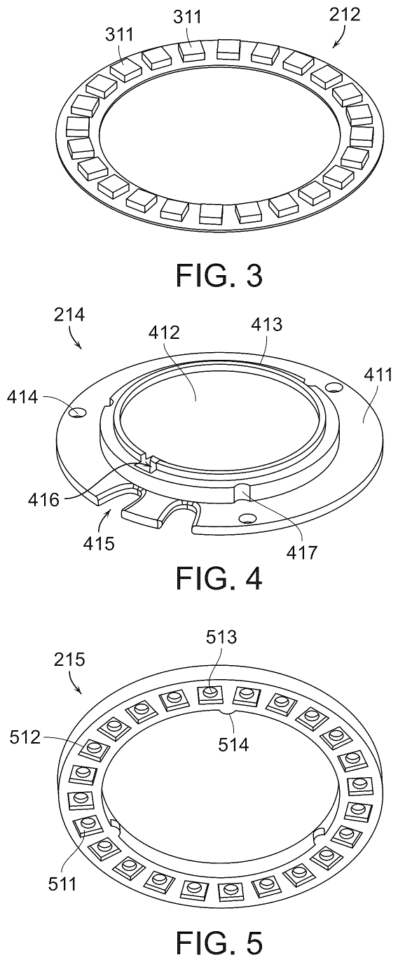

FIG. 3 shows the shape of the LED ring 212 that generates light via LEDs 311 according to patterns programmed by a microcontroller (not shown) or computer (not shown).

FIG. 4 shows tray 214 for mounting the LED ring 212 and the wireless charger 213 within the holder 216. Tray 214 comprises an LED ring mounting surface 411 for mounting the LED ring on top of a circumferential surface of the tray 214. Charger mounting surface 412 allows for the wireless charger 213 to be mounted on top of an inner circular surface of the tray 214 while the charger retention wall 413 holds the wireless charger 213 in place. The charger retention wall 413 additionally mates with a circular cutout (see FIG. 2) under the cover 111 to allow for slidable engagement between the tray 214 and the cover 111. Mounting holes 414 allow for the tray to mate with pegs (not shown) projecting from the holder 216.

Ring wiring slots 415 allow for wiring from the LED ring 212 to drop down and connect with a microcontroller (not shown) or computer (not shown). Likewise, charger wiring slot 416 allows for the wiring from the transmitting coil of the wireless charger 213 to drop down and connect with a PCB and/or controller 232.

FIG. 5 shows a gasket 215 that is mounted on top of the LED ring 212. In an assembled state of the wireless charging slab for an electronic device, the LED ring 212 is mounted on the mounting surface 412 of the tray 214 and the gasket is mounted on the LED ring 212 such that the LEDs 311 of the LED ring 212 fill the LED cavities 511 of the gasket 215. The gasket 215 has a flexible grid 512 for ease of assembly.

In accordance with FIGS. 1, 2, 4, and 5, the flexible grid guide holes 513 allow for the insertion of light pipes 211 into the gasket such that at least one surface of the light pipes 211 is adjacent and/or in physical contact with at least one surface of the LEDs 311 and a second surface of the light pipes 211 is configured to project light from the light pipe holes 113 in the cover 111 through the surface of the cover 111 to create a light display for the user.

According to FIGS. 1-5, while assembled, the mounting protrusions 514 of gasket 215 allow the gasket to be located around the tray 214 by sliding the mounting protrusions 514 into the gasket locating slots 417 of the tray 214 such that a circular or arc edge of the locating slots 417 in tray 214 is concentric with a circular or arc edge of the mounting protrusions 514 of gasket 215.

### Communication and Control

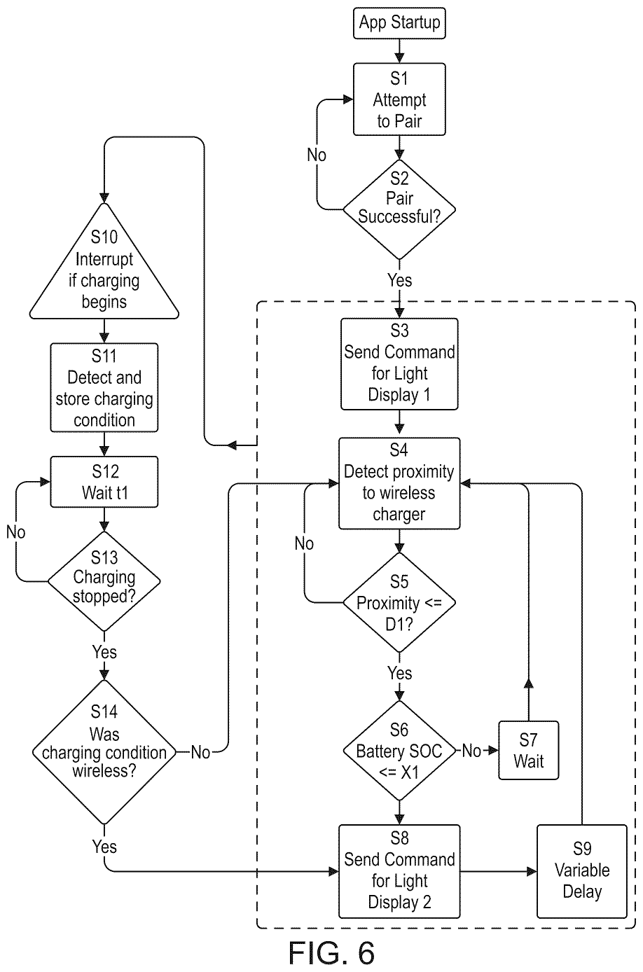

FIG. 6 describes embodiments of a process for using a wireless or wired charging slab for an electronic device and the interaction between the controller 232 of the charging slab and the electronic device 230. Communication from the electronic device begins when an application or computer program stored in a computer readable medium that is installed on the electronic device begins and/or is initiated by the user. In embodiments, the electronic device may be a personal computer, laptop, mobile telephone, or wearable electronic device such as a watch, bracelet, hearing aid, or other medical device.

In accordance with FIG. 2, the electronic device 230 uses EM communication (electromagnetic communication) 231 to communicate with a controller 232. The controller may be a computer that stores and executes code in a computer readable medium and/or a microcontroller. In an embodiment the electronic device 230 and controller 232 have two-way or one-way communication. In a preferred embodiment the electronic device 230 sends commands to the controller to execute tasks such as controlling the LED ring 212 to perform a light display. In an embodiment, commands from the electronic device 230 are sent asynchronously via one or more byte arrays over the air.

In an embodiment the electronic device 230 utilizes an application or computer program to send commands to the microcontroller. The flow chart in FIG. 6 describes a preferred embodiment of the operation of an application installed on the electronic device 230.

The app begins at app startup when the app is opened and/or initiated by the user. In step S1, the app attempts to pair the electronic device 230 with the controller 232, via electromagnetic (EM) communication. Pairing is a process of mutually registering information in a secure and/or encrypted and persistent manner. EM communication is used by the electronic device 230 to transmit data to and/or from the controller 232. Controller 232 may have an antenna or be in electrical communication with an antenna to enable EM communication with the electronic device 230. Examples of EM communication are Bluetooth, Wi-Fi, Bluetooth Low Energy (BLE), NFC, or any other EM communication that is between 1 kHz and 10 GHz in frequency.

In step S2, if the pairing is unsuccessful, then pairing is retried after a suitable delay until the pair is successful. If the pairing is successful then the control sequence of the electronic device 230 proceeds to S3.

In an alternative embodiment steps S1 and S2 do not involve pairing, i.e. establishing a secured and/or persistent connection between the electronic device 230 and the controller 232. In an alternative embodiment to steps S1 and S2 the electronic device 230 detects a broadcast and/or recurring advertisement sent over the air by the controller 232 and proceeds to step S3 when the advertisement is detected by electronic device 230 without establishing a persistent and/or exclusive connection.

In step S3, the electronic device 230 sends a command to the controller 232 to initiate light display 1. Light display 1 may be a greeting display and/or display a depiction representing the state of charge of the battery of the electronic device 230. In an embodiment, light display 1 occurs when the signal strength detected by electronic device 230 from the EM communication with the controller 232 is greater than a minimum signal strength as set by the user or as stored as a default minimum signal strength in the memory of electronic device 230. Light display 1 may be the same as or different from light display 2 in step S8.

In step S4, the electronic device 230 detects the proximity of the wireless charger 213 or charging slab. In an embodiment, proximity is detected by the electronic device 230 by measuring the strength of the EM communication signal originating from the wireless charger 213 or charging slab. In an embodiment the electronic device 230 detects the received strength of signal indicator, i.e. RSSI, to determine the signal strength and proximity. In another embodiment, proximity is detected by a proximity detector in the electronic device 230 or in the charging slab. In an embodiment, the electronic device 230 may play a clicking or beeping sound that increases in frequency as the electronic device 230 is closer to the wireless charger 213 or charging slab. This feature is particularly useful for alerting the visually impaired that the electronic device 230 is in a low battery condition and in need of charge and so that a visually impaired user can easily find the location of the charging slab. In an alternative embodiment, the electronic device 230 may be configured by the user with a custom audio file that is recordable via the same application or program installed on the electronic device 230. In an embodiment the electronic device 230 can be configured to play a custom audio file uploaded by the user and the custom audio file can be played by the electronic device 230 more frequently when the strength of signal from the charging slab is stronger.

In step S5, the electronic device 230 returns the control flow to S4 if the proximity is not less than or equal to a value of distance D1, the preferred proximity detection distance, and proceeds to S6 if the proximity value is equal to or less than D1. The preferred proximity distance D1, i.e. the maximum activating distance, may be at least approximately determined by the strength of the signal, or RSSI, coming from the wireless charger 213 (or the charging slab) or by any other proximity detection means known in the art. D1 may be a calibrated and/or preset value, for example a value known to correspond to an unobstructed distance of 30 cm between the electronic device 230 and the wireless charger 213 or charging slab. An example of a preset RSSI value that corresponds approximately to 30 cm for a small microcontroller with EM communication capabilities is approximately −30 to −40 decibel milliwatts (dBm). In other embodiments, the preferred proximity distance D1 may be between 5 cm and 5 meters. Alternatively, D1 may be configurable by the user such that the user chooses the distance at which the electronic device 230 alerts the user of a low battery condition.

In an embodiment, the electronic device 230 may, for example, be a wearable device with a button or touch interface whereby the distance D1 is set by the user by pressing the button or touch interface of the electronic device 230 or optionally after holding the button for a predetermined time at a user-chosen distance away from the wireless charger 213 or charging slab to set the preferred proximity distance D1 into the memory of the electronic device 230. In another embodiment, the distance D1 can be set by an app installed on a mobile device which determines the distance at which the electronic device 230 commands the controller 232 to alert the user of, for example, a low battery condition. When the decision of the electronic device 230 to send commands to the charging slab is based on the proximity of the charging slab to the electronic device 230, unwanted light displays are prevented at times when the electronic device 230 is not proximate to the charging slab.

In step S6, the electronic device 230 determines whether the battery state of charge (SOC) is in a low condition. If the battery SOC is greater than X1, which is a percentage between 1% and 100% representing the state of charge detected in electronic device 230, then the control sequence proceeds to step S7 to wait for a predetermined period of time, such as five seconds, before proceeding back to step S4. In step S6, X1 may be preset or set by the user manually.

In step S6, if the battery SOC is less than or equal to X1, then the control sequence proceeds to step S8. In step S8, the electronic device 230 commands the controller 232 to perform light display 2 for the user. Light display 2 may be the same as or different from light display 1. In an embodiment light display 2 represents the SOC of the battery such that the LEDs light up in an amount that is at least approximately proportional or related to the SOC.

In step S9, after the electronic device 230 commands the controller 232 to begin light display 2, a variable delay is imposed. For example, this variable delay may be one minute, five minutes, 10 minutes, 30 minutes, one hour, or vary between any of those delays depending on user preference. The variable delay is used to avoid saturating the user with light displays from the wireless charger 213 or charging slab. In an embodiment, the variable delay can increase if no charging begins, can increase or decrease based on the usage pattern of the wireless charger 213 or charging slab, or can be configured and/or set by the user. In an embodiment, the less the wireless charger 213 or charging slab is used, the less the controller 232 alerts the user of the need to charge.

In step S10, the electronic device 230 detects that the battery of the electronic device 230 has begun charging and interrupts any step in the control sequence contained in the box formed by the dashed lines. The interrupt in S10 is performed by electronic device 230 sending a command to the controller 232 to stop displaying because the user no longer needs a reminder to begin charging the electronic device 230. In an alternative embodiment, when charging begins the SOC of the battery of the electronic device 230 is communicated to the user through a light display for a period of time, periodically at predetermined intervals, or during the entire duration of charging.

In step S11, the electronic device 230 detects the charging condition and stores it in a computer readable memory. In an embodiment of a wireless charger 213, the charging condition can be at least one of a wired charging condition or a wireless charging condition, which is detected and/or determined by the electronic device 230. In another embodiment for a charging slab which may be wireless or wired, the charging condition is at least one of a first condition where the charging slab is performing the charging and a second condition where the charging slab is not performing the charging, which is detected by the charging slab and communicated to the electronic device 230 by the charging slab via EM communication.

In step 512, the electronic device 230 waits for a time t1. In a preferred embodiment the time t1 is at least 10 milliseconds and at most two minutes.

In step 513, the electronic device 230 performs a check to determine if the charging has stopped. If the charging has not stopped, electronic device 230 sends the control sequence back to step S12 to wait again. If, in step S13, the charging has stopped, the control sequence proceeds to step S14.

In step 514, the electronic device 230 performs a check to determine if the charging condition was wireless by looking at the charging condition that was stored in a computer readable medium in the electronic device 230 from step S11. If the charging condition was wireless (yes) then the control sequence proceeds to S8, thereby sending a command for light display 2. Light Display 2 may be, for example, a display that communicates the state of charge, SOC, of the battery to the user, thereby showing the current SOC after use of the charging slab. If the charging condition was not wireless (no) then the control sequence proceeds to step S4.

In an alternative embodiment, in step S14 the electronic device 230 considers whether the charging condition is a first condition where the charging slab is performing the charging and a second condition where the charging slab is not performing the charging. If the electronic device 230 determines that the condition is the first condition (yes), then the control sequence in S14 proceeds to S8. If the charging condition is the second condition (no), then the control sequence in S14 proceeds to S4.

The purpose of delineating whether the charging is wireless or, in an alternative embodiment, whether a wireless charger is being used, is to prevent the wireless charger or charging slab from creating displays when it is not being used by the user.

### Light Display Pattern

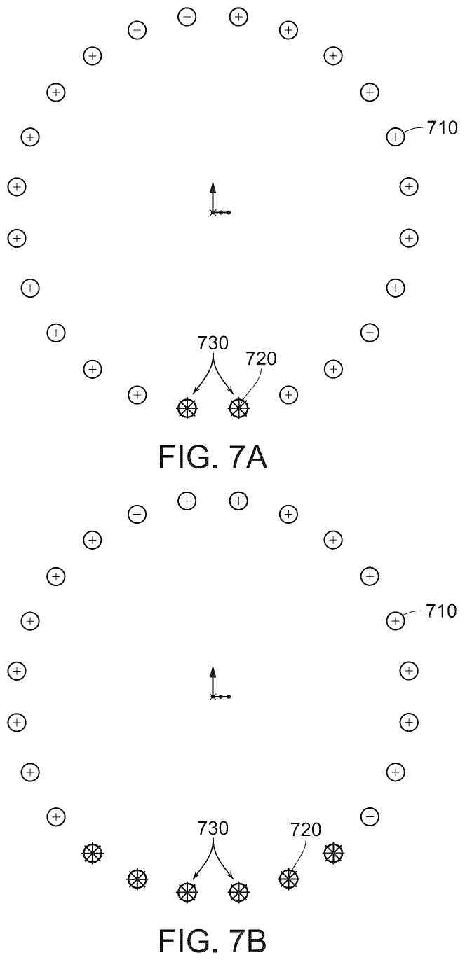

FIGS. 7A and 7B show an example of how light display 2 in step S8 of FIG. 6 can be created. In an embodiment the number of lights that light up from the wireless charger 213 or charging slab is proportional to the number 1-100 representing the state of charge of the battery of the electronic device 230. In the embodiment of FIGS. 7A and 7B, there are 24 LED lights which propagate light through the light pipes 211 (as shown in FIG. 2) around a circular pattern. 24 LEDs, problematically, do not always proportionally divide the SOC values that are between 1 and 100 (when multiplied by a conversion factor of 100) into integers. In an embodiment the LEDs in LED ring 212 can be controlled by the controller 232 to light up in a mirrored, pairwise fashion, such that when the SOC detected by the electronic device 230 is represented by a remapped value between 1 and 12 representing the cumulative number of pairs displayed from a first direction to a second direction that is at least approximately opposite the first direction (e.g. from the bottom to the top of the plane of the slab surface). The number of mirrored pairs displayed may generally follow equation 1 below.

Xₚₐᵢᵣₛ=┌(100*Y_{SOC}−Sᵢₙₜ|*Nₘₚ)/100┐+1 (1)

Where Xₚₐᵢᵣₛ is the number of mirrored pairs which are displayed to the user through the light pipes 211, Y_{SOC} is the percentage of the SOC of the battery of the electronic device 230, which, when multiplied by a factor of 100, represented as an integer from 1-100, Sᵢₙₜ is the adjustment integer, Nₘₚ is the number of available mirrored pairs (i.e. the total number of LEDs divided by two), ∥ is the absolute value symbol, and ┌ ┐ represents the floor function which takes a real number as an input and returns the largest integer that is not greater than that number.

In an embodiment with 24 LEDs, the scaling integer Sᵢₙₜ is at least 1 and at most 8. In a preferred embodiment the scaling integer Sᵢₙₜ is 8.

For example, in FIG. 7A, where Sᵢₙₜ=8: if the SOC is 1%, Xₚₐᵢᵣₛ=1, i.e. there is one set of mirrored pairs 730 that are shown by two active LEDs shown by two active lights 720 and 22 inactive LEDs shown by inactive lights 710.

In FIG. 7B if the SOC is 27%, Xₚₐᵢᵣₛ=3, i.e. there are three sets of mirrored pairs 730 that are shown by six active LEDs 720 and eighteen inactive LEDs 710.

This invention is not limited to a configuration of 24 LEDs. It is understood that any number of LEDs can be utilized and that mirrored pairs of lights can be used to convey a state of charge to the user. When the light pipes are arranged in any symmetrical or approximately symmetrical pattern, the mirrored pairs are displayed symmetrically or approximately symmetrically about an axis of symmetry to the user.

In a preferred embodiment Sᵢₙₜ can be calculated from equation 2 below.

Sᵢₙₜ=┌33−(100*(⅓−1/Nₘₚ))┐ (2)

Where Sᵢₙₜ is the adjustment integer, Nₘₚ is the number of available mirrored pairs (i.e. the total number of LEDs divided by two).

The advantage of using mirrored pairs is that it is easily recognizable, grabs the attention of the user, and can be understood no matter the angular position of the user provided the charging slab is in the user's line of sight. The advantage of using an adjustment integer Sᵢₙₜ that is represented in equation 2 is that it presents the user with a closely quantized remapping of the SOC, such that, e.g. in a 24 LED arrangement, the break point for one third of the LEDs being active occurs when the SOC goes from 32% to 33%. In addition, the break point for one half of the LEDs being active occurs when the SOC goes from 49% to 50%. Establishing the breakpoints in such a way makes the user experience more intuitive.

Generally, the light display patterns are useful for the hearing impaired, who may not hear or see alerts from the electronic device 230. The light display patterns generated according to FIG. 7 and equations 1 and 2 are particularly useful because they inform the user of the SOC of an electronic device 230 at a distance. In an embodiment, the electronic device 230 is a medical device, such as a hearing aid, that reminds the user that electronic device 230 needs recharging at a predetermined or user-defined SOC.

In another embodiment, the electronic device 230 electrically connects with the charging slab, via electrical contacts on the electronic device 230 that electrically communicate with electrical connectors in the charging slab. Wired connection between the charging slab and the electronic device 230 has the advantage of being more energy efficient and offers faster charging capabilities for certain electronic devices.

### Implementation

The types of EM communication used in this invention are not limited. In a preferred embodiment, the protocol of communication is Bluetooth® (trademark of Bluetooth SIG, Inc.). In a preferred embodiment, the protocol of communication is Bluetooth Low Energy or BLE.

In one embodiment, the electronic device 230 acts as a central device (i.e. transmitting device) and the charging slab with controller 232 acts as a peripheral (i.e. receiving device). In a further embodiment, the central device, i.e. electronic device 230, periodically detects whether the peripheral, i.e. charging slab, is advertising. Advertising is a process whereby the controller 232 periodically broadcasts byte arrays that identify the peripheral via a Universal Unique Identifier (UUID) and describe services which contain logical groupings of characteristics, wherein the characteristics are communicated by the byte arrays that are transmitted by the central device, i.e. electronic device 230, and received by the peripheral in order for the central device to command the peripheral to perform a task. Services can describe to the central device what kind of tasks can be performed by the device, providing a menu of commands. One example of a characteristic is in step S8, where the controller commands the charging slab to perform light display 2, which can indicate to the user the SOC of the battery of the electronic device 230. To command the charging slab to perform light display 2, electronic device 230 sends a byte array to controller 232, which the controller recognizes as a command via the characteristic to initiate light display 2. This has the advantage that the detection portion of the reminder is processed by and stored in the memory of the electronic device 230 and the light display portion of the reminder is processed by and, at least temporarily, stored into the memory of the controller 232. This keeps the bulk of processing and memory utilization in the electronic device 230 and the more time sensitive light display portion with the controller 232.

Other embodiments can employ different methods and protocols that obtain the same results. For example, pairing is not required for the charging slab to advertise a service and for the electronic device 230 to send commands via characteristics and/or byte arrays to the charging slab. In addition, BLE is an asynchronous protocol, however, other embodiments can employ synchronous protocols. In other non-limiting embodiments, Bluetooth Classic, Wi-Fi, or NFC protocols can be used. In addition, other types of wireless communication between the electronic device 230 and the controller 232 can be performed, for example inductive coupling between the power transmitting coils contained in the electronic device 230 and the charging slab can communicate information such as the state of charge of the battery to the charging slab.

### Embodiment 2

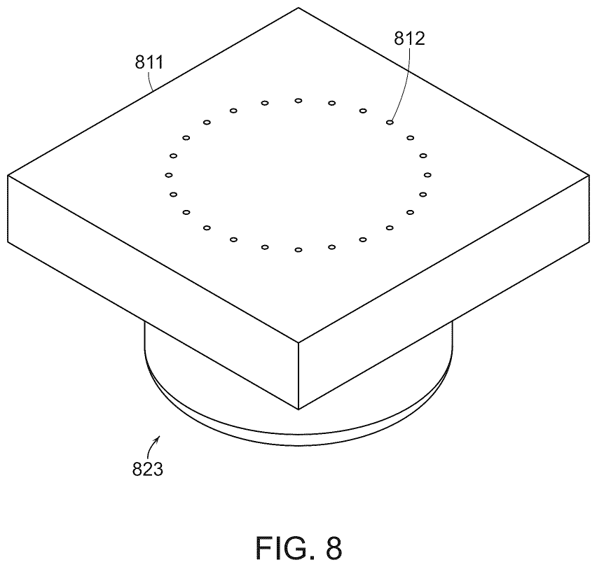

FIG. 8 shows slab 811 and light propagating volumes 812 which end at the surface of slab 811. A cassette protective casing 823 is depicted beneath the slab and contains components for the wireless charger for an electronic device.

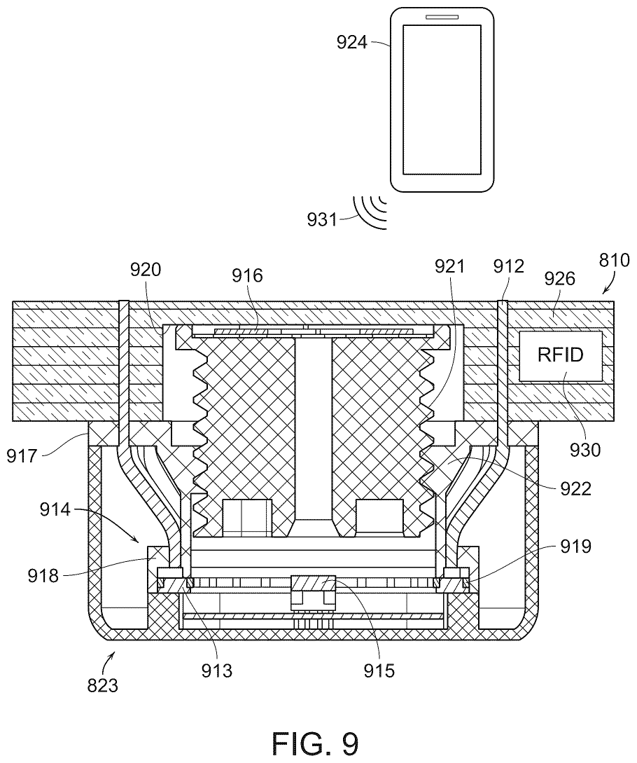

FIG. 9 shows a cross-sectional view of a slab 811 that is embedded with light propagating volumes 912 running from the top slab surface 810 to LED ring 913. A gasket 919, which can be made of a flexible material formed into a grid, is located on top of LED ring 913 and fits around the individual LEDs of LED ring 913. Each individual light propagating volume of light propagating volumes 912 is mounted on top of a corresponding individual LED of the LED ring 913. Each light propagating volume of the light propagating volumes 912 is uniquely associated with a specific LED. The gasket 919 serves the function of blocking light emitted by adjacent LEDs from entering a light propagating volume of the light propagating volumes 912 that does not correspond with the specific LED that the light propagating volume is uniquely associated with, thereby creating a crisp and point like display to the user and preventing light from bleeding.

A cassette 914 contains computer 915, LED ring 913, gasket 919, and one of a plurality of terminal ends of the light propagating volumes 912 which are opposite an other plurality of terminal ends of the light propagating volumes 912 located at or adjacent to the top slab surface 810. Cassette 914 is a hollow cylinder with a top opening and a cavity to house components and is fitted with a cassette lid 918 to cover the top of cassette 914.

In alternative embodiments, the power transmitting coil 916 is approximately or completely pressed flush against the interior bottom slab surface 920.

Male screw 921 of cassette 914 engages with female screw 922 of screw plate 917. Cassette protective casing 823 engages with screw plate 917 to protect the cassette 914 and its components and to hide the cassette 914 and other components from the user's view. Cassette protective casing 823 has a female screw that engages a male screw of screw plate 917 to fasten the protective casing 823 and the screw plate 917 together.

The computer 915 may be a microcontroller to reduce cost or may be composed of a computer processor, e.g. CPU, and a computer readable memory wherein the computer processor executes instructions in the computer readable memory for controlling the electrical components, such as the power transmitting coil 916 and LED ring 913.

The power transmitting coil 916 transmits power to a power receiving coil (not shown) that is either in an electronic device 924 (shown in FIG. 9), or in electrical communication with electronic device 924, thereby charging a battery of the electronic device 924 while power is transmitted. The electronic device 924 may be, for example, a portable phone, ear buds, or a laptop computer.

Inductive charging or resonant charging can alternatively be utilized in the present invention. In alternative embodiments the power transmitting coil 916 transfers power to a power receiving coil either by inductive coupling or via resonance between the power transmitting coil 916 located in the charger and a power receiving coil (not shown) in the electronic device 924.

The wireless charger for an electronic device of embodiment 2 can be constructed by drilling slab holes 926 through the top of the slab. Screw plate guide holes in the screw plate 917 are aligned with the slab holes 926 and screw plate 917 is fastened to the bottom of the slab via screws, bolts, adhesive or any other suitable fastener known in the art. The cassette 914 is loaded with components and mated to the screw plate 917 via a male screw 921 of the cassette 914 which forms a mating configuration with the female screw 922 of the screw plate. The male screw 921 and female screw 922 allow for the height of the power transmitting coil 916 to be adjusted closer to or further away from the interior bottom slab surface 920.

One of a plurality of terminal ends of the light propagating volumes 912 are mounted on the LED ring 913. The light propagating volumes 912 are run through the gasket 919, a plurality of cassette lid guide holes in the cassette lid 918, screw plate guide holes of the screw plate 917, and slab holes 926 of the slab 811. The other plurality of terminal ends of the light propagating volumes 912 terminate at or adjacent to the top of the slab 811. In an embodiment, light propagating volumes 912 may be made of fiber optic material, acrylic, or polycarbonate.

Once the light propagating volumes 912 are in place, the cassette protective casing 823 is fastened by a female screw located on the cassette protective casing 823 that interacts with an outer male screw on the screw plate 917. Alternatively, the cassette protective casing 823 may be attached to the screw plate by adhesive, screws, posts, or any other suitable fastening means known in the art.

Other embodiments are contemplated where more than one matrix of LEDs is used. The LED matrix or matrices may be individually addressable and programmable via a computer that has a computer processor unit and a computer memory unit which is composed of a computer readable medium that stores code for controlling the LEDs in preconfigured patterns so that point sources of light are displayed from the top of the slab in a desired pattern. In one embodiment the LED matrix or matrices may be one or more NEOPIXEL® displays. (NEOPIXEL® is a registered trademark of Limor Fried in the United States). The LED matrix or matrices may be in the shape of a rectangle, square, or ring. The point sources of light emitting from the terminal ends of the light propagating volumes can be arranged in the shape of a circle, wherein the power transmitting coil 916 resides inside the circle so as to create a visual cue for the user for locating the hidden wireless charger residing within the slab.

In other embodiments the power transmitting coil may be forgone entirely and the point sources of light emitting from the terminal ends of the light propagating volumes in the slab may instead be used as a simple indicator display for any hidden electronic device, such as a hardwired electric charger or other electrical connector, or as a sign for displaying a logo or as an artistic display.

### Embodiment 3

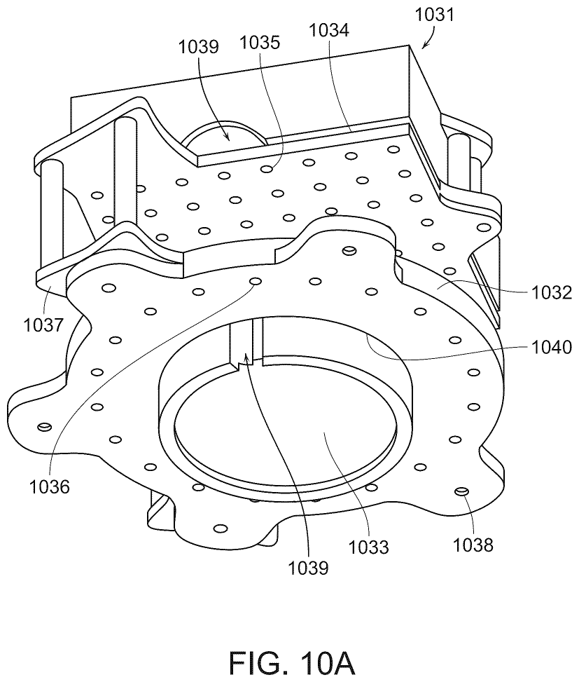

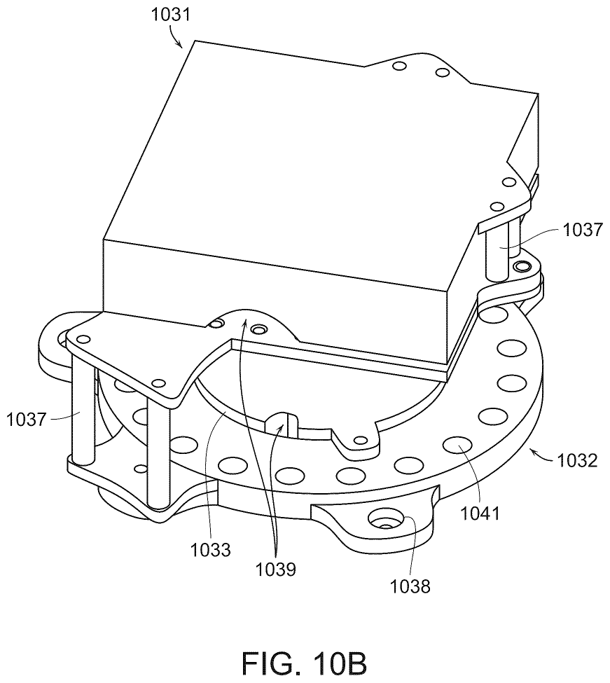

FIGS. 10A and 10B show a cassette box 1031, screw plate 1032, and coil mount 1033 of the present invention, which are part of an integrated cassette.

Referring to FIGS. 10A and 10B, cassette box 1031 is a five-sided prismatic shell or hollow box with a rectangular cassette lid 1034. Cassette lid guide holes 1035 allow for light propagating volumes to be fed from the cassette box 1031 to screw plate guide holes 1036 and into slab holes in a slab (not shown). The cassette lid guide holes 1035, screw plate guide holes 1036, and slab holes (not shown) may have a diameter that is substantially the same as the diameter of the light propagating volumes. In an embodiment the diameter of the screw plate guide holes 1036 is larger than the diameter of the cassette lid guide holes 1035 and the slab holes (not shown) so that a jacketed portion of the light propagating volumes is substantially the same diameter as the screw plate guide holes 1036, while unjacketed terminal ends of the light propagating volumes have substantially the same diameter as the smaller diameter cassette lid guide holes 1035 and slab holes (not shown). The jacketed portion of the light propagating volumes may include a sheath of optically opaque material that surrounds the light propagating volumes.

In an embodiment, light propagating volumes may be held in place via adhesive wells 1041 surrounding the screw plate guide holes 1036. The adhesive wells 1041 are configured to hold adhesive in contact with the light propagating volumes.

The cassette box 1031, cassette lid 1034, and screw plate 1032 may be fastened together via attachment posts 1037 which can be friction fit, screwed, bolted in, or adhered to the components with an adhesive or any other suitable fastening method known in the art.

Screw plate hole 1040 allows for coil mount 1033 to enter through the center of the screw plate 1032. The coil mount 1033 holds a power transmitting coil (not shown) and, in alternative embodiments, can be adjustable in a vertical direction or can be fastened to the screw plate 1032 at a predetermined height to bring the power transmitting coil near the bottom of the slab surface.

Wiring slots 1039 allow for the electrical components such as a power transmitting coil (not shown), a computer (not shown), and LED matrix to receive power and communication wiring.

Screw holes 1038 allow for the screw plate 1032 to be screwed into the underside of a slab (not shown).

### OTHER EMBODIMENTS

In another embodiment the controller 232 is configured to initiate a light display when a primary alert and/or notification is detected by the electronic device 230, which sends a command to the controller 232 to display a light display routine or light routine from the charging slab representing a secondary alert and/or notification for the user.

In an embodiment the electronic device 230 may act as a secondary notification platform. When acting as a secondary notification platform the electronic device 230 is configurable by the user such that alerts are cloned, duplicated, and/or mirrored, i.e. a primary alert received by the electronic device 230 will be detected and cause the electronic device 230 to send a secondary alert to the controller 232 to initiate a programmed light display to the user indicating that an alert has been received by the electronic device 230. Examples of alerts and notifications are app notifications, push notifications, text messages, low battery notifications, incoming calls, emails, or other reminders, notifications, or events in the app as is known in the art. In an embodiment the electronic device 230 is configured by the user to only clone the alerts that the user desires, thereby allowing for a customizable user experience. In an embodiment, the alerts and/or notifications are classified into classifications and the color or pattern of the programmed light display is specific to the classification of the alert. For example, email alerts can be classified as red programmed light displays, while text alerts can be classified as green programmed light displays. This paradigm can be extended to any number of colors representing any number of notifications. In another example, emails can be associated with a first display routine and text message can be associated with a second display routine that is a different pattern of lights from the first display routine. In an embodiment, the number of unread alerts can be communicated to the user by the charging slab by displaying a number of lights that is equal or proportional to the number of unread alerts. In an embodiment a programmed custom light display can be tailor-made for alerts originating from a specific entity, person, or company based on colors and/or light display patterns.

When acting as a secondary notification platform, the charging slab can be configured to send alerts that represent a numerical value in a way that the numerical value is communicated or approximately communicated to the user. For example, when the electronic device 230 receives an alert that there is a low battery condition that is 35% of the maximum SOC of the battery, the electronic device 230 sends a command to the charging slab to produce a light display that is at least approximately proportional to 35% of the total number of available light propagating volumes, i.e. the number of available lights. In another example, such as a wearable fitness tracker, when the electronic device receives or detects an alert that the progress of an exercise activity is, for example, 75% complete the electronic device 230 sends a command to the charging slab to produce a light display that is at least approximately proportional to 75% of the total number of light propagating volumes.

In an embodiment, the user can manually set a preferred notification distance relative to the proximity of the electronic device 230. If the electronic device 230 is within range of the preferred notification distance, the alert, for example the battery level or a cloned text message alert, is transmitted to the user via a light display from the charging slab. If the electronic device 230 is not within the preferred notification distance, e.g. the RSSI is too low, the alert is not communicated.

In an embodiment the light propagating volumes may take on any shape. For example, the light propagating volumes may be cylindrical, star shaped, or square. In an embodiment the light propagating volumes may be arranged in the pattern of a design or logo along a surface of the charging slab.

In an embodiment, the charging slab is activated by an active, passive, or semipassive RFID (radio frequency identification) or NFC (near field communication) tag in the electronic device 230 that communicates with an RFID or NFC reader in the charging slab. When the RFID or NFC reader in the charging slab confirms that the electronic device 230 is an approved device, the charging slab requests that or commands the electronic device 230 communicate the SOC of the battery to the charging slab.

The invention described herein is not limited to a singular cassette, matrix, or screw plate. Further embodiments may be composed of multiple light generating matrices that are contained in multiple cassettes that feed into multiple screw plates and/or arrays of slab holes. It is further contemplated that a singular matrix in a singular cassette may provide light propagating volumes to multiple screw plates.

### Method of Manufacturing

A mask with a prearranged pattern of drilling guide holes is secured to the top or bottom surface of a slab. Slab holes are drilled partially or completely through the slab via the drilling guide holes. A portion of the slab is hollowed from the underside to provide a cavity underneath, so that the power transmitting coil can be located near enough to the surface of the slab to effectively charge an electronic device when the electronic device is placed on the top surface of the slab. A screw plate with one or more screw plate screw holes is positioned so that screw plate guide holes are aligned with the slab holes on the bottom side of the slab. The screw plate may have a hole through the middle to allow for the insertion of a coil mount which supports the power transmitting coil from below and/or in a gravity direction.

In an embodiment, the screw plate may be aligned such that the screw plate hole is concentric with the cavity under the slab, allowing for the coil mount to be positioned inside the cavity. After alignment is complete, the screw plate is fastened to the bottom of the slab with fasteners, e.g. bolts, screws, or is attached with an adhesive.

A gasket in the shape of a grid is seated on top of an LED matrix such that grid holes in the gasket surround the LEDs. The LED matrix and gasket are placed in a box cassette via a top opening in the box cassette. Other components may be inserted into the box cassette such as power or communication wiring and a computer for controlling the wireless charger.

Electrical connections between the LED matrix and computer are made. A power wire which connects to an external battery or to a power outlet may be fed through an opening or slot in one of the side or bottom walls of the cassette in order to provide power to the electrical components. A top plate or lid is fastened, wherein the lid matches the top-down silhouette of the cassette to close the top opening. The LED matrix and gasket may be held in place via pressure or friction from the lid and cassette wall which circumscribes the perimeter of the cassette opening.

The power transmitting coil is positioned on the coil mount and wiring is fed down a hollow shaft or through a slot in the coil mount and connected to the computer and/or power wiring. The coil mount is adjusted in an up and down direction so that the power transmitting coil is properly positioned to charge an electronic device placed on the slab. The power transmitting coil can be made flush or substantially flush with the bottom of the slab depending on safety and efficiency considerations.

The box cassette is fastened to the screw plate or alternatively to the slab. One of a plurality of terminal ends of the light propagating volumes are fed into cassette lid guide holes in the cassette lid and then an other of a plurality of terminal ends of the light propagating volumes are fed through the screw plate guide holes and slab holes. This step can be performed by resting the top surface of the slab on a flat working surface such that the top surface of the slab is facing a gravity direction, thereby forming a stop to prevent the terminal ends of the light propagating volumes from protruding beyond the top surface of the slab. This makes the terminal ends of the light propagating volumes coplanar or substantially coplanar with the top surface of the slab. In another embodiment a stop plate can be pushed against the top surface of the slab to act as a stop. In a further embodiment the stop plate may have stopping protrusions to stop the light propagating volumes from reaching the top surface of the slab thereby allowing a gap to be formed between the top surface of the slab and the terminal ends of the light propagating volumes. In a further embodiment this gap may be filled with a translucent or transparent filler to ensure an even top surface that prevents fouling and dust collection.

The filler may be sacrificial, thus allowing for it to be removed in the event of scuffing or fouling with, for example, a screw shaped extractor. In the event a used filler is removed, it can be replaced with a new filler material. The filler material may be transparent plastic, such as transparent polyethylene, glass, acrylic, PMMA, polycarbonate, or fiber optic material. The filler may be a solid, puck-shaped cylinder that is pushed into place or it may be installed by pouring or injecting a thermosetting resin material into the gap.

In a further embodiment, a translucent or transparent varnish may be applied to at least the top surface of the slab whether or not a gap exists between the terminal ends of the light propagating volumes and the slab surface. The thickness of the varnish or filler is preferably between 0.01 mm and 8 mm to prevent light scattering through the varnish thickness during operation of the wireless charger for an electronic device. The varnish may likewise be applied over the filler material. Optionally, the index of refraction of the filler material and/or varnish N_{f} may be between 0.5% and 10% of the index of refraction of the light propagating volumes Nₛ such that the percent refractive difference R_{diff} is less than or equal to 10% in accordance with the following in equation 3:

R_{diff}=|(N_{f}−Nₛ)|/(N_{f}+Nₛ)<10% (3)

In a preferred embodiment R_{diff} is less than 1%, less than 0.5%, or minimized as much as is practicable.

In an embodiment, an overlayer of ink, resin, semitransparent plastic, decal or other semitransparent material is applied over the slab holes to further camouflage the terminal ends of the light propagating volumes. The overlayer may be located in, under, or on top of the varnish layer depending on the requirements.

### Alternative Manufacturing Method

This method has the advantages of reducing costs and improving the speed of manufacturing.

The power transmitting coil, computer, wiring, light generating matrix, gasket, light propagating volumes, and optionally an RFID reader are first placed into an integrated cassette, which is an integrated module of at least two of a cassette box, a screw plate, and a coil mount. The cassette box, screw plate, and/or coil mount of the integrated cassette may be made from a resin material, such as injection molded or heat molded plastic.

A slab is formed with one or more cavities and a pattern of slab holes through a top surface of the slab. The one or more cavities can be formed using a router Alternatively, the slab may be resin based and have pre-formed cavities and/or slab holes, such as the case where the slab is manufactured from an injection molding process.

In an embodiment the integrated cassette utilizes stiff light propagating volumes such that an armature or suitable joining device is capable of aligning and sliding light propagating volumes projecting in a direction out of the integrated cassette into a slab with pre-formed holes, whereby the light propagating volumes are inserted into the pre-formed holes in the process.

The light propagating volumes may be made of injection molded transparent material or may be made of stiff fiber optic cables. In the present embodiment, the elastic modulus of the light propagating volumes is preferably greater than 10 GPa, 100 GPa, or more preferably greater than 200 GPa. After the light propagating volumes are inserted into the slab holes, the integrated cassette is fastened to the bottom of the slab and optionally the ends of the light propagating volumes protruding from the top of the slab are sheared. In an embodiment wiring for the wireless charger may be connected to an electrical power source via trenches along or holes inside the bottom of the slab or in compartments in the slab that conceal the wiring.

In an embodiment, the light propagating volumes may be contained in an opaque sheath of material with a stiffness of preferably greater than 10 GPa, 100 GPa, or more preferably greater than 200 GPa. The light propagating volumes may be held in place via glue, a clamp, or frictional protrusions inside of or adjacent to the slab holes which act to catch the light propagating volumes and hold them in place. In an embodiment the light propagating volumes are made of injection molded material, such as injection molded acrylic (e.g. PMMA) or polycarbonate (PC).

All embodiments described herein are for explanatory purposes. One skilled in the art will recognize that changes may be made to the form and detail of the embodiments without departing from the scope or understanding of the invention. The claims and their full range of equivalents are therefore not intended to be limited by the scope or theory of the detailed description presented.

What is claimed:

1. A charging slab for an electronic device comprising:
a charging slab, light propagating volumes contained in the slab, which are configured to emit a first number of active lights from a first surface of the slab, a controller located in said charging slab configured to control a matrix of light generators contained within the slab, wherein the matrix of light generators emit light through the light propagating volumes to emit said first number of active lights, wherein the controller is configured to send and/or receive communication via EM communication; and
an electronic device comprising a computer which further comprises a computer readable medium and a processor configured to read and write data in the computer readable medium, wherein the electronic device is configured to send and receive said EM communication, and said electronic device is configured to send at least a first command to the controller;
wherein said first command is sent when a first condition is detected by the electronic device and said first command commands the controller to cause the matrix of light generators to emit light through the light propagating volumes in a first programmed light display pattern comprising said first number of active lights.

2. The charging slab for an electronic device as in claim 1, wherein the first condition detected is a first percentage representing a state of charge (SOC) in a battery in the electronic device, and wherein a second percentage representing said first number of active lights in said first programmed light display pattern divided by a total number of available lights is approximately equal to said first percentage.

3. The charging slab for an electronic device according to claim 2, wherein said first number of active lights are displayed in a paired, mirror-wise fashion about an axis, wherein said axis is located at an axis of symmetry or approximately located at the axis of symmetry of said total number of available lights.

4. The charging slab for an electronic device according to claim 2, wherein said electronic device is configured to send the first command to said charging slab when said first condition is satisfied, said first condition being satisfied when said SOC is determined by said computer of said electronic device to be less than or equal to a percentage X1, representing a low battery SOC, wherein said charging slab is configured to display a first light routine when said controller determines said first command was received.

5. The charging slab for an electronic device according to claim 4, wherein said electronic device is configured to send a second command to said charging slab when a first alert is received by said computer, wherein said first alert comprises a first notification for at least one of an email, a phone call, a text, or an event in an app installed on the computer of the electronic device.

6. The charging slab for an electronic device of claim 5, wherein said charging slab is configured to display a second light routine that is the same as or different from said first light routine when said controller determines that said second command was received, thereby mirroring said first alert received by the computer.

7. The charging slab for an electronic device of claim 6, wherein said electronic device is configured to send a third command to said charging slab when a second alert is received by said computer, wherein said second alert comprises a second notification for at least one of an email, a phone call, a text, or an event in an app installed on the computer of the electronic device.

8. The charging slab for an electronic device of claim 7, wherein said charging slab is configured to display a third light routine, which is different from said second light routine, when said controller determines that said third command was received, thereby mirroring said second alert received by the computer.

9. The charging slab for an electronic device of claim 8, wherein said first notification is a different type of notification than said second notification.

10. The charging slab for an electronic device of claim 9, wherein a first color of said second light routine is different than a second color of said third light routine.

11. The charging slab for an electronic device of claim 10, wherein said first, second, and third commands are represented by byte arrays sent over the air asynchronously by the electronic device to the charging slab.

12. A low battery alert platform comprising:
a charging slab, light propagating volumes contained in the slab, which are configured to emit a first number of active lights from a first surface of the slab, a controller located in said charging slab configured to control a matrix of light generators contained within the slab, wherein the matrix of light generators emit light through the light propagating volumes to emit said first number of active lights, wherein the controller is configured to send and/or receive communication via EM communication; and
an electronic device comprising a computer which further comprises a computer readable medium and a processor configured to read and write data in the computer readable medium, wherein the electronic device is configured to send and receive said EM communication, and said electronic device is configured to send at least a first command to the controller;
wherein said first command is sent when a first condition is detected by the electronic device and said first command commands the controller to cause the matrix of light generators to emit light through the light propagating volumes in a first programmed light display pattern comprising said first number of active lights.

13. The low battery alert platform of claim 12, wherein said first condition is satisfied when a low battery condition is detected by the electronic device.

14. The low battery alert platform of claim 12, wherein said first condition is satisfied when a distance between the electronic device and the charging slab is less than a maximum activating distance.

15. The low battery alert platform of claim 12, wherein the first condition is satisfied when a signal strength of the EM communication from the charging slab to the electronic device is greater than a minimum signal strength.

16. The low battery alert platform of claim 12, further comprising an RFID or NFC tag contained within the electronic device and an RFID or NFC tag reader contained within the charging slab, wherein the first condition is satisfied when the RFID or NFC tag reader reads the RFID or NFC tag.

17. A method of manufacturing a wireless charger embedded in a slab, comprising the steps of:
forming a slab comprising one or more cavities with openings at a bottom slab surface;
forming an integrated cassette comprising a screw plate, a cassette box and a coil mount;
inserting an LED matrix and a computer into the cassette box, wherein said computer comprises a processor and a computer readable medium which stores computer executable code, wherein the computer is configured to control the LED matrix, and the LED matrix comprises a plurality of LEDs that are configured to be individually addressable by the computer; and
fastening a cassette lid on said cassette box.

18. The method of claim 17, further comprising the steps of:
mounting a power transmitting coil onto said coil mount and connecting said power transmitting coil to the computer, wherein the computer is configured to control the power transmitting coil; and
feeding a plurality of light propagating volumes into the integrated cassette via a first plurality of guide holes in the cassette lid and a second plurality of guide holes in the screw plate such that the light propagating volumes project out of the integrated cassette in a first direction.

19. The method of claim 18, further comprising the steps of:
forming a third plurality of guide holes in the slab;
before or after the step of feeding the plurality of light propagating volumes into the integrated cassette, aligning the plurality of light propagating volumes with said third plurality of guide holes;
inserting the plurality of light propagating volumes into the third plurality of guide holes in the slab such that terminal ends of the plurality of light propagating volumes are coplanar or substantially coplanar with a top surface of the slab; and
fastening with at least one screw the integrated cassette to the underside of the slab via screw holes in the screw plate.
